(19) United States
(12) Patent Application Publication
(10) Pub. No.: US 2011/0268036 A1
(43) Pub. Date: Nov. 3, 2011

(54) COMMUNICATION SYSTEM, TUNNEL MANAGEMENT SERVER, COMMUNICATION DEVICE, TUNNEL SETUP METHOD, AND PROGRAM

(76) Inventor: Yasuhiro Mizukoshi, Tokyo (JP)

(21) Appl. No.: 13/143,398

(22) PCT Filed: Dec. 25, 2009
(86) PCT No.: PCT/JP2009/071623

§ 371 Date: Jul. 6, 2011

(30) Foreign Application Priority Data
Jan. 20, 2009 (JP) 2009-009851

(51) Int. Cl. H04W 8/26; H04L 12/56

(52) U.S. Cl. 370/328; 370/400

(57) ABSTRACT

A communication system comprises a first communication device that transmits a setup request that causes a tunnel to be set up such that a first tunnel address of said first communication device and a second tunnel address of a second communication device are tunnel interfaces and a tunnel management server that receives said setup request from said first communication device and that, when said second communication device has a plurality of said second tunnel addresses, combines said plurality of second tunnel addresses and said first tunnel address and sets up a plurality of tunnels.

### TECHNICAL FIELD

The present invention relates to a tunneling technique serving to register addresses to tunnel interfaces.

### BACKGROUND ART

MCoA (Multiple Care-of Address Registration), which is an extension format of Mobile IP, has been evaluated by IETF (Internet Engineering Task Force). This is a format that serves to register a plurality of care-of addresses to a home agent (HA) when a mobile node (MN) is simultaneously connected to a plurality of networks.

When the MCoA format is used while a mobile node has been connected to a plurality of networks, the mobile node can switch from one path to another path depending on the characteristics of data or simultaneously transmit the same packets to the plurality of paths so as to prevent services being affected by packet losses.

For example, a mobile node described in Patent Document 1 (JP No. 2003-18193A) registers unique care-of addresses to individual home agents (HAs). When the mobile node uses a care-of address correlated with a home agent of a desired ISP (Internet Service Provider) network, the mobile node can forward packets through the desired ISP network.

On the other hand, if a home agent is connected to a plurality of networks, home agent addresses corresponding to the networks are allocated to the individual communication interfaces of the home agent. In the ordinary Mobile IP format, in the state in which the individual home agent addresses are just correlated with the individual care-of addresses, communication is made between the home agent and mobile node. When the mobile node tries to change the home agent address correlated with the care-of address, the mobile node needs to obtain a list of these home agent addresses.

For example, Non-patent Document 1 (RFC5142 “Mobility Header Home Agent Switch Message”) describes a technique in which when a home agent changes its communication interface, it notifies a mobile node of a list of addresses that it can register. Non-patent Document 2 (C. N G. K. Aso: “On Mobile IPv6 Optimization and Multihoming,” IETF, July, 2008) describes a technique in which a home agent notifies a mobile node of the characteristics of the communication interface that the home agent has.

The mobile nodes described in Non-patent Document 1 and Non-patent Document 2 can obtain a plurality of home agent addresses that the home agent has based on the address list and the characteristics of the communication interface. When these mobile nodes request the home agent to register any one of these home agent addresses, they can switch from the existing path to another one.

### DISCLOSURE OF THE INVENTION

However, in the techniques described in Patent Document 1, Non-patent Document 1, and Non-patent Document 2, communication between a mobile node and a home agent occasionally becomes inefficient.

Specifically, as shown in FIG. 32, although the node described in Patent Document 1 can transmit data through a plurality of networks (NW3, NW4) to which the node is directly connected, namely a plurality of paths, even if there are a plurality of networks (NW1, NW2) that are connected to the home agent side, the mobile node can transmit data to the home agent only through one network (NW1). This means that the communication system described in Patent Document 1 permits only one home agent address that is correlated with a care-of address and that is registered.

On the other hand, in the communication systems described in Non-patent Document 1 and Non-patent Document 2, since only one home agent address can be correlated with a care-of address and registered, even if a plurality of networks are connected to the home agent, the mobile node can transmit data to the home agent only through one of these networks.

When the mobile node allocates particular communication from a network of the existing home agent to a network of another home agent, the mobile node needs to request the other home agent to register the care-of address of the mobile node that is correlated with its home agent addresses.

Whenever the home agent registers a care-of address, it needs to update the registered contents and notify the mobile node of the updated contents.

Thus, the mobile node (communication device) needs to request the home agent (communication device) to reregister the care-of address of the mobile node and thereby the home agent needs to notify the client of the updated contents and thereby communication therebetween becomes inefficient.

An object of the present invention is to provide a technique that allows communication between communication devices to become efficient.

### SUMMARY OF THE INVENTION

To accomplish the foregoing object, a communication system according to the present invention comprises: a first communication device that transmits a setup request that causes a tunnel to be set up such that a first tunnel address of said first communication device and a second tunnel address of a second communication device are tunnel interfaces; and a tunnel management server that receives said setup request from said first communication device and that, when said second communication device has a plurality of said second tunnel addresses, combines said plurality of second tunnel addresses and said first tunnel address and sets up a plurality of tunnels.

A tunnel management server according to the present invention comprises: reception means that receives a setup request that causes a tunnel to be set up such that a first tunnel address of a first communication device and a second tunnel address of a second communication device are tunnel interfaces; and setup means that receives said setup request from said reception means and that, when said second communication device has a plurality of said second tunnel addresses, combines said plurality of second tunnel addresses and said first tunnel address and sets up a plurality of tunnels.

A communication device according to the present invention is a communication device that transmits a multiple setup request that causes a plurality of tunnels to be set up such that a first tunnel address of a first communication device and a second tunnel address of a second communication device are tunnel interfaces.

A tunnel setup method according to the present invention is a tunnel setup method, comprising: transmitting a setup request that causes a tunnel to be set up such that a first tunnel address of said first communication device and a second tunnel address of a second communication device are tunnel interfaces; and receiving said setup request from said first communication device and that, when said second communication device has a plurality of said second tunnel addresses, combining said plurality of second tunnel addresses and said first tunnel address and setting up a plurality of tunnels.

A program according to the present invention is a program that causes a computer to execute steps, comprising: receiving a setup request that causes a tunnel to be set up such that a first tunnel address of a first communication device and a second tunnel address of a second communication device are tunnel interfaces; and receiving said setup request from said reception step and that, when said second communication device has a plurality of said second tunnel addresses, combining said plurality of second tunnel addresses and said first tunnel address and setting up a plurality of tunnels.

According to the present invention, when a tunnel management server receives a setup request that causes a tunnel to be set up such that a first tunnel address and a second tunnel address are tunnel interfaces, if there are a plurality of second tunnel addresses, the tunnel management server combines the plurality of second tunnel addresses and the first tunnel address and sets up a plurality of tunnels. Thus, the tunnel management server does not need to set up a tunnel whenever a path is changed, nor does it needs to inform the first communication device that setting has been changed and thereby the communication efficiency between communication devices improves.

### BRIEF DESCRIPTION OF DRAWINGS

FIG. 1 is an overall view illustrating a structure of a communication system according to a first embodiment of the present invention;

FIG. 2 is a block diagram illustrating a structure of a mobile node according to the first embodiment of the present invention;

FIG. 3 is a block diagram illustrating a structure of a home agent according to the first embodiment of the present invention;

FIG. 4 is a diagram listing contents stored in a management table according to the first embodiment of the present invention;

FIG. 5 is a diagram illustrating information contained in a registration packet according to the first embodiment of the present invention;

FIG. 6 is a diagram illustrating information contained in a response packet according to the first embodiment of the present invention;

FIG. 7 is a flow chart illustrating an operation of the MN according to the first embodiment of the present invention;

FIG. 8 is a flow chart illustrating an operation of the HA according to the first embodiment of the present invention;

FIG. 9 is a schematic diagram illustrating a flow of data in the communication system according to the first embodiment of the present invention;

FIG. 10 is a schematic diagram illustrating a flow of data in an ordinary communication system;

FIG. 11 is a schematic diagram illustrating a flow of data in the communication system according to the first embodiment of the present invention;

FIG. 12 is a schematic diagram illustrating a flow of data in an ordinary communication system;

FIG. 13 is a schematic diagram illustrating a flow of data in the communication system according to the first embodiment of the present invention;

FIG. 14 is a schematic diagram illustrating a flow of data in an ordinary communication system;

FIG. 15 is a block diagram illustrating a structure of a mobile node according to a second embodiment of the present invention;

FIG. 16 is a block diagram illustrating a structure of a home agent according to the second embodiment of the present invention;

FIG. 17 is a diagram listing contents stored in a management table according to the second embodiment of the present invention;

FIG. 18 is a diagram illustrating information contained in a registration packet according to the second embodiment of the present invention;

FIG. 19 is a diagram illustrating information contained in a response packet according to the second embodiment of the present invention;

FIG. 20 is a diagram illustrating information contained in a flow registration request according to the second embodiment of the present invention;

FIG. 21 is flow chart illustrating an operation of the MN according to the second embodiment of the present invention;

FIG. 22 is a flow chart illustrating a flow registration request process according to the second embodiment of the present invention;

FIG. 23 is a flow chart illustrating an operation of the HA according to the second embodiment of the present invention;

FIG. 24 is a sequence chart illustrating an operation of a communication system according to the second embodiment of the present invention;

FIG. 25 is an overall view illustrating a structure of a communication system according to a third embodiment of the present invention;

FIG. 26 is a diagram listing contents stored in a management table according to the third embodiment of the present invention;

FIG. 27 is a diagram illustrating information contained in a registration packet according to the third embodiment of the present invention;

FIG. 28 is a schematic diagram illustrating information contained in a response packet according to the third embodiment of the present invention;

FIG. 29 is a diagram illustrating information contained in a flow registration request according to the third embodiment of the present invention;

FIG. 30 is a sequence chart illustrating an operation of the communication system according to the third embodiment of the present invention;

FIG. 31 is a schematic diagram illustrating a flow of data in the communication system according to the third embodiment of the present invention; and

FIG. 32 is a schematic diagram illustrating a flow of data in an ordinary communication system.

### DESCRIPTION OF EMBODIMENTS

### First Embodiment

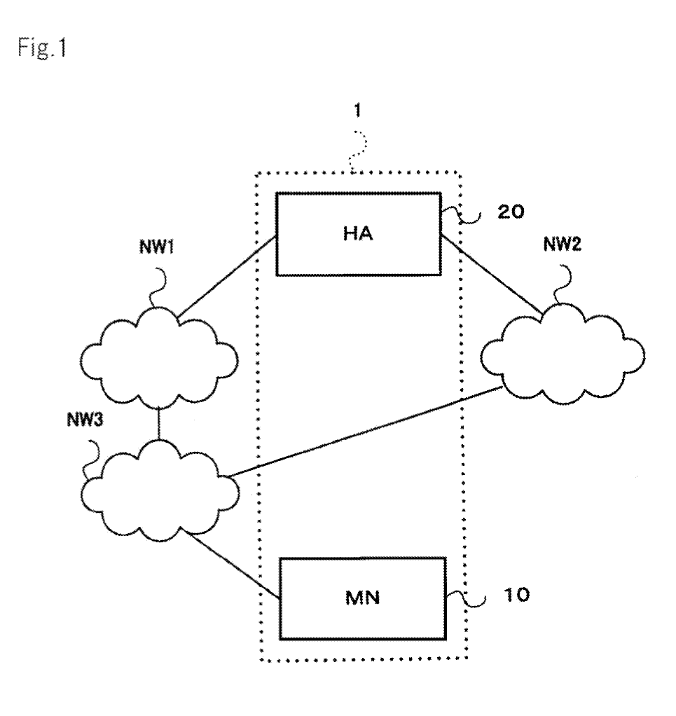

With reference to drawings, a first embodiment of the present invention will be described. FIG. 1 is an overall view illustrating a structure of communication system 1 according to this embodiment. Communication system 1 uses the Mobile IP (Internet Protocol) as a communication protocol. Referring to the drawing, communication system 1 has MN (Mobile Node) 10 and HA (Home Agent) 20. MN10 and HA 20 are connected to a plurality of networks such as NW 1, NW 2, and NW 3.

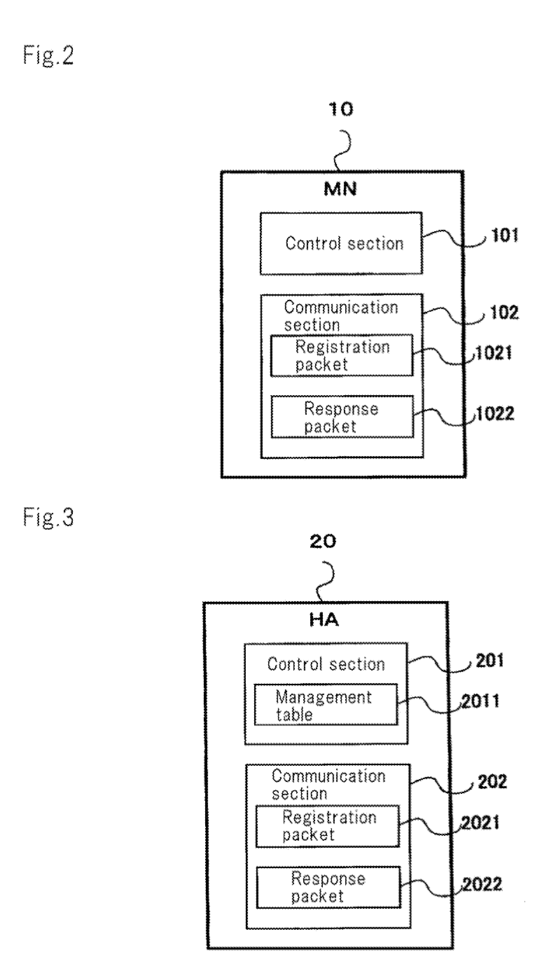

FIG. 2 is a block diagram illustrating a structure of MN10 (first communication device). MN10 is a mobile node such as a mobile telephone device. Referring to the drawing, MN10 has control section 101 and communication section 102.

Control section 101 receives an agent advertisement that notifies MN10 of the presence of an agent such as HA 20 on the link, refers to the agent advertisement, and detects that MN10 itself has moved. When control section 101 detects that MN10 itself has moved, control section 101 obtains a care-of address (CoA) that MN10 adds as information that represents the transmission source in data communication through an IP tunnel.

Then, communication section 102 transmits to HA 20 registration packet 1021 that has correlated the home address (HoA) of MN10 with the care-of address so as to request the communication party (HA 20) to register (set up) an IP tunnel between MN10 and HA 20.

An IP tunnel is set up when HA 20 registers a CoA corresponding to the home address of MN10 as one tunnel interface of the IP tunnel and the home agent address (HAA) as the other tunnel interface.

A home address is an address uniquely allocated to MN10. A CoA is an address (first tunneling address) that MN10 obtains to use an IP tunnel. An HAA is an address (second tunneling address) that is allocated in advance to a communication interface of HA 20.

After the IP tunnel is set up, the transmission side (MN10, HA 20) encapsulates a packet that contains the home address and so forth with a header containing a CoA and an HAA and then transmits the encapsulated packet. The reception side (HA 20, MN10) removes an encapsulation from the encapsulated packet (IP tunneling). The IP tunneling allows MN10 to make communication at a moving destination.

For example, if MN10 transmits a packet to another node through HA 20, MN10 generates a packet containing information denoting that the transmission source is its home address. Then, MN10 adds (encapsulates) a header containing information denoting that the transmission source is the CoA and the transmission destination is the HAA to the packet. Then, MN10 transmits the encapsulated packet to HA 20. Then, HA 20 removes the header from the encapsulated packet, obtains (decapsules) the packet, and then transfers the packet.

Registration packet 1021 also contains Multi HA Address Opt flag. The Multi HA Address Opt flag is turned on when MN10 causes all IP tunnels to be registered where a plurality of HAAs are tunnel interfaces; the Multi HA Address Opt flag is turned off when MN10 causes an IP tunnel to be registered where any one of the HAAs is a tunnel interface. This flag is initially turned off. When the communication state is not satisfactory or packets need to be transmitted simultaneously through a plurality of paths, MN10 turns on this flag.

When HA 20 receives the registration packet from MN10, HA 20 sends back response packet 1022 that denotes that the requested IP tunnel has been set up to MN10. As will be described later, the response packet contains an HAA correlated with a CoA and registered. Communication section 102 receives response packet 1022. After the IP tunnel has been set up, when MN10 communicates with HA 20, MN10 transmits and receives data having the header containing the registered CoA and HAA.

FIG. 3 is a block diagram illustrating a structure of HA 20 (second communication device). HA 20 functions as an IP tunneling registration server (tunnel management server) that registers a tunnel interface on the side of MN10 and a tunnel interface on the side of the communication party (HA 20). Referring to the drawing, HA 20 has control section 201 and communication section 202.

Communication section 202 receives registration packet 2021 (1021) that causes an IP tunnel to be registered (set up) based on a home agent (HoA) and a care-of address (CoA) from MN10.

Control section 201 determines whether or not the Multi HA Address Opt flag contained in registration packet 2021 is turned on. When this flag is turned on and there are a plurality of HAAs in HA 20, control section 201 sets up IP tunnels for all combinations in which the CoA of MN10 is one tunnel interface and one of the plurality of HAAs is the other tunnel interface. Control section 201 registers the setup contents in management table 2011.

Then, communication section 202 transmits response packet 2022 (1022) containing tunnel setup address information that represents the registered HAA(s) correlated with CoA to MN10.

After the IP tunnel(s) has been set up, the node as the communication party (HA 20, etc) performer communication with MN10 by transmitting and receiving data having the header containing the registered CoA and HAA(s).

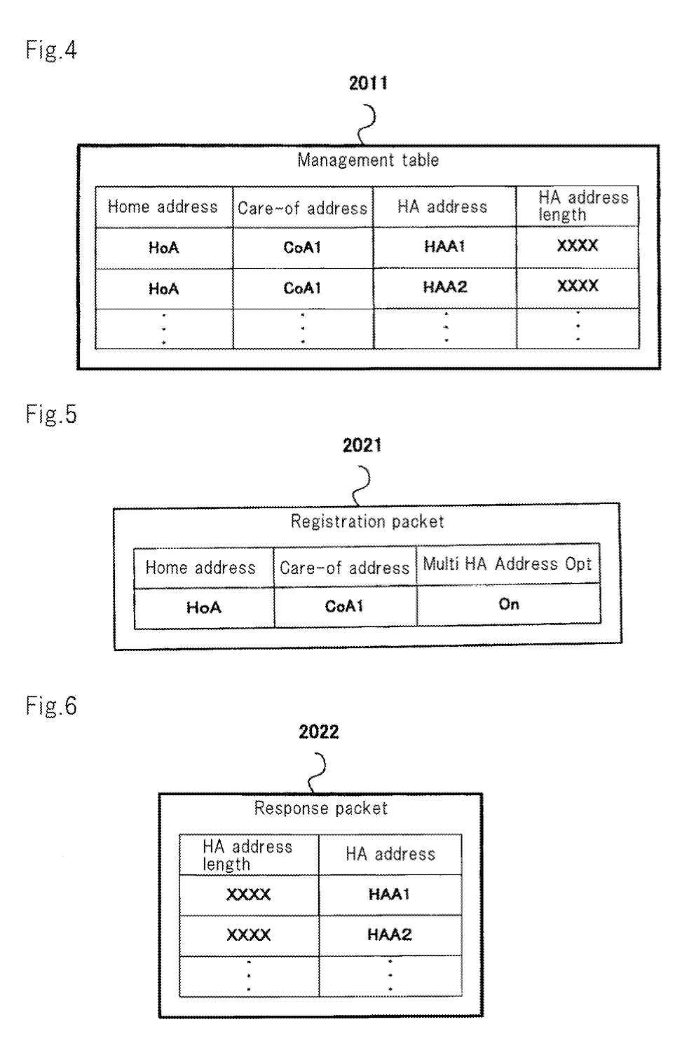

FIG. 4 is a table listing contents of management table 2011. Referring to the drawing, management table 2011 stores information that represents “home address,” “care-of address,” “HA address,” and “HA address length.” Management table 2011 stores combinations of “care-of address” and “HA address” corresponding to “Home address” of each mobile node.

“Home address” is an address uniquely allocated to MN10.

“Care-of address” is an address registered as a tunnel interface on the side of MN10 when an IP tunnel is set up. When MN10 transmits data by the IP tunneling, MN10 stores “care-of address” as the transmission source to the header.

“HA address” is an address registered as a tunnel interface on the side of the communication party (HA 20) when an IP tunnel is set up. When the communication party (HA 20) of MN10 transmits data, this node stores “HA address” as the transmission source to the header.

“HA address length” is the length of the “HA address” and is added to represent the IP version. For example, when the IP version is IPv4 (Internet Protocol Version 4), “4” is stored as “HA address length.” When the IP version is IPv6 (Internet Protocol Version 4), “6” is stored as the “HA address length.”

For example, it is assumed that MN10 causes a care-of address “CoA1” to be correlated with a home address “HoA” to be registered and that HA addresses “HAA1” and “HAA2” have been allocated to interfaces of HA 20.

In this case, if the “Multi HA Address Opt” flag of registration packet 2021 is turned on, HA 20 registers (sets up) all combinations in which “CoA l” corresponding to “HoA” is one tunnel interface and “HAA1” or “HAA2” is the other tunnel interface. If the “Multi HA Address Opt” flag is turned off, HA 20 registers one combination in which “CoA” corresponding to “HoA” is one tunnel interface and “HAA1” is the other tunnel interface.

FIG. 5 is a diagram illustrating information contained in registration packet 2021. Referring to the drawing, registration packet 2021 contains information that represents “home address,” “care-of address,” and “Multi HA Address Opt.”

“Multi HA Address Opt” is a flag that denotes whether or not MN10 causes all HAAs to be registered if HA 20 has a plurality of HAAs.

FIG. 6 is a diagram illustrating information contained in response packet 2031. Referring to the drawing, response packet 2022 stores “HA address length” correlated with “HA address.” “HA address” is an HAA that HA 20 registers in management table 2011 based on the registration packet received from MN10.

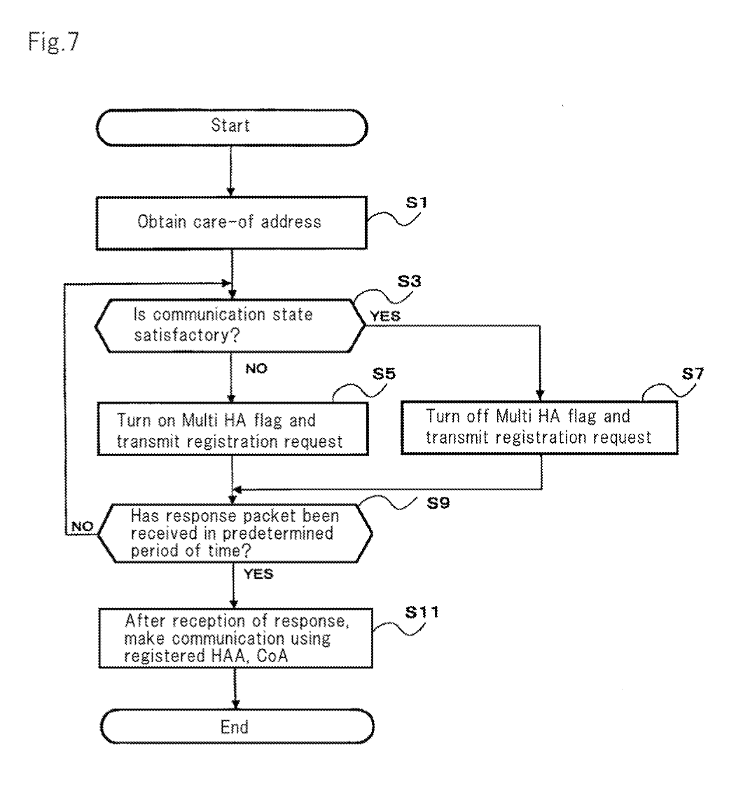

FIG. 7 is a flow chart illustrating an operation of MN10. This operation starts when MN10 detects its movement. Referring to the drawing, MN10 refers to an agent advertisement and generates a care-of address of the link after the movement of MN10 (at step S1).

MN10 determines whether or not the communication state is satisfactory (at step S3). For example, MN10 determines whether or not the communication state is satisfactory depending on whether or not the communication speed at which MN10 communicates with another node is equal to or greater than a predetermined value.

When the communication state is not satisfactory (at step S3: NO), MN10 transmits registration packet 1021 with the Multi HA Address Opt flag turned on (multiple setup request) (at step S5). When the communication state is satisfactory (at step S3: YES), MN10 transmits registration packet 1021 with the Multi HA Address Opt flag turned off (setup request) (at step S7).

After step S5 or S7, MN10 determines whether or not it has received response packet 1022 (2022) from HA 20 in a predetermined period of time (at step S9).

When MN10 has not received response packet 1022 (at step S9: NO), MN10 returns to step S3. When MN10 has received response packet 1022 (at step S9: YES), MN10 extracts the registered HAA from the packet. Then, MN10 transmits and receives data by IP tunneling in which the combination of the registered CoA and HAA is used as tunnel interfaces (at step S11). For example, when a plurality of tunnels in which a plurality of HAAs are tunnel interfaces have been set up, MN10 transmits packets simultaneously through the plurality of IP tunnels. After step S11, MN10 completes the operation.

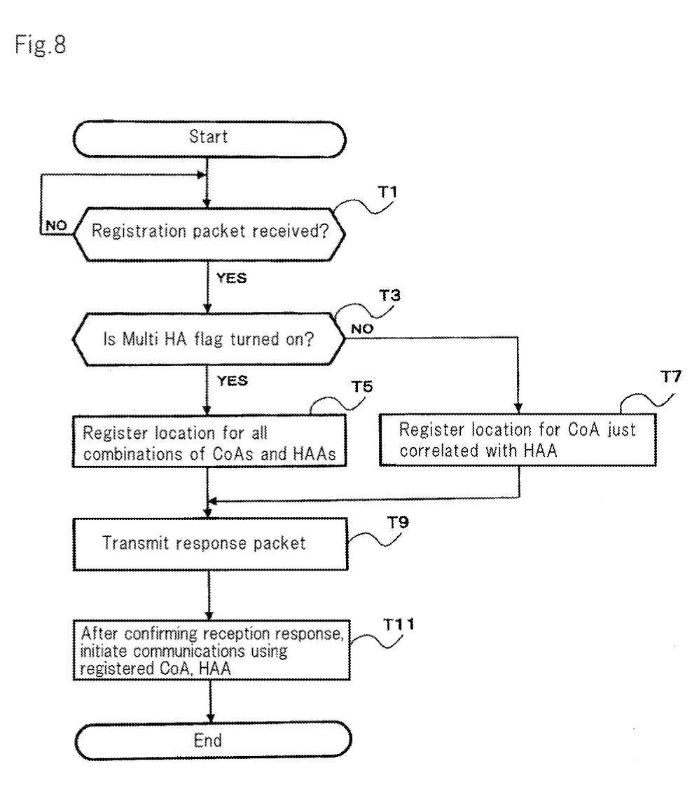

FIG. 8 is a flow chart illustrating an operation of HA 20. This operation starts when the power of HA 20 is turned on or when a predetermined application is executed. Referring to the drawing, HA 20 determines whether or not it has received registration packet 2021 (1021) from MN10 (at step T1). When HA 20 has not received registration packet 2021 (at step T1: NO), HA 20 returns to step T1. When HA 20 has received registration packet 2021 (at step T1: YES), HA 20 determines whether or not the “Multi HA Address Opt” contained in the packet is turned on (at step T3).

When the flag is turned on (at step T3: YES), HA 20 registers all combinations of CoA and HAAs corresponding to HoA in management table 2011 (at step T5). When the flag is turned off (at step T3: NO), HA 20 registers one combination of CoA and HAA corresponding to HoA in management table 2011 (at step T7).

After step T5 or T7, HA 20 transmits response packet 2022 that contains address information that represents the registered HAA to MN10 (at step T9). After confirming the reception response of response packet 2022, HA 20 transmits and receives data by IP tunneling that uses the combination of the registered CoA and HAA as tunnel interfaces (at step T11). After step T11, HA 20 completes the operation.

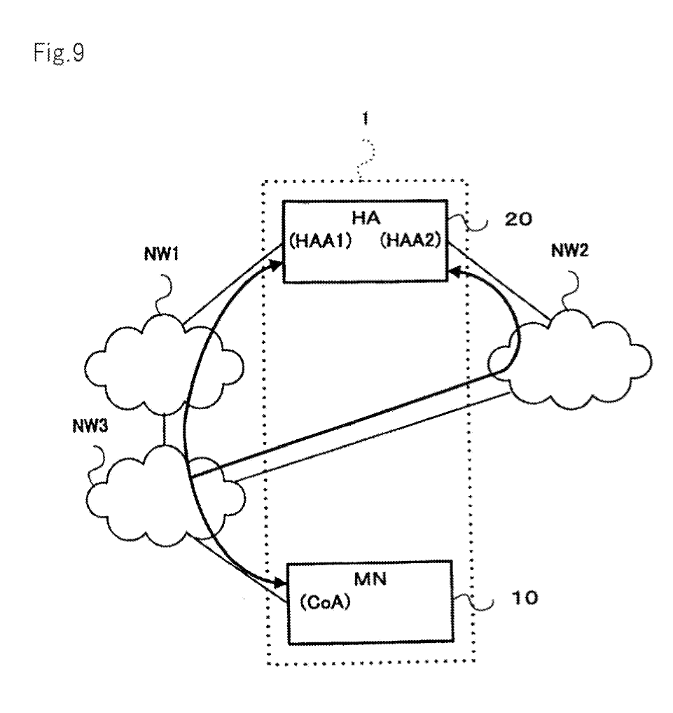

Next, with reference to FIG. 9 to FIG. 14, an exemplified operation of communication system 1 will be described. FIG. 9 is a schematic diagram illustrating a flow of data in the case in which MN10 turns on the Multi HA Address Opt flag and transmits a registration request with this flag and then HA 20 registers a combination of CoA1 and HAA1 and a combination of CoA1 and HAA2. As shown in the drawing, since MN10 has caused IP tunnels having a plurality of HAAs as tunnel interfaces to be registered, MN10 can transmit data through the plurality of IP tunnels. Thus, even if the communication state is not satisfactory, since the same packets can be transmitted through the plurality of tunnels, communication quality can be improved. In addition, if the communication quality of one IP tunnel is not satisfactory, MN10 can switch from this IP tunnel to another one and thereby communication quality can be improved.

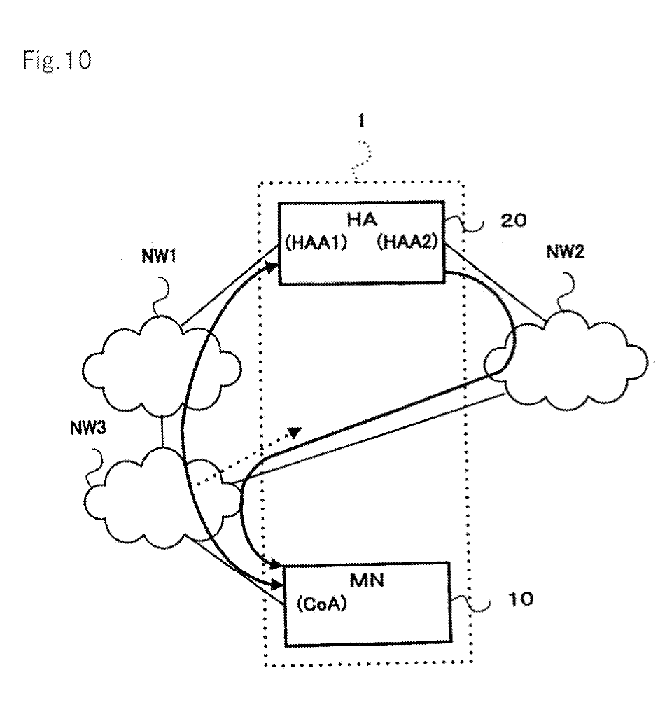

In contrast, as shown in FIG. 10, when the Multi HA Address Opt flag is turned off or when an ordinary registration packet that does not contain the Multi HA Address Opt flag is transmitted, CoA1 is just correlated with HAA1 and registered. Thus, MN10 cannot transmit data through an IP tunnel having tunnel interfaces of CoA1 and HAA2 that have not been registered. To switch from the existing IP tunnel to the IP tunnel having the interfaces of CoA1 and HAA2, MN10 needs to transmit the registration request to HA 20 again. In addition, whenever HA 20 registers CoA and HAA, it needs to notify MN10 of the updated contents and thereby communication between MN10 and HA 20 becomes inefficient.

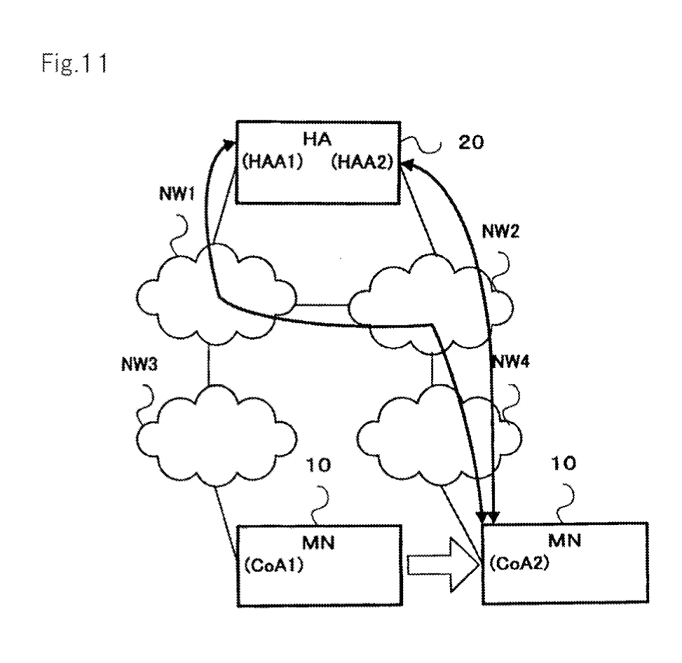

FIG. 11 is a schematic diagram illustrating the flow of data in the case in which MN10 has moved from one area to another area, MN10 has turned on the Multi HA Address Opt flag and transmitted the registration request, and HA 20 has registered a combination of CoA2 and HAA1 and a combination of CoA1 and HAA2 after the movement of MN10. Referring to the drawing, since a plurality of IP tunnels corresponding to the plurality of HAAs have been registered, after the movement of MN10, it can also transmit data through the plurality of IP tunnels.

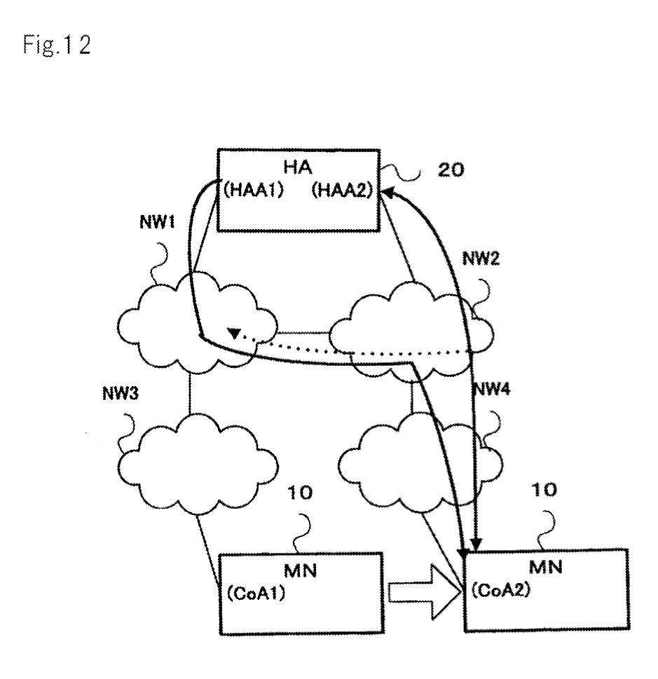

In contrast, as shown in FIG. 12, when the Multi HA Address Opt flag is turned off or when an ordinary registration packet that does not contain the Multi HA Address Opt flag is transmitted, CoA2 is just correlated with HAA2 and registered. Thus, MN10 cannot transmit data through an IP tunnel corresponding to CoA2 and HAA1 that have not been registered.

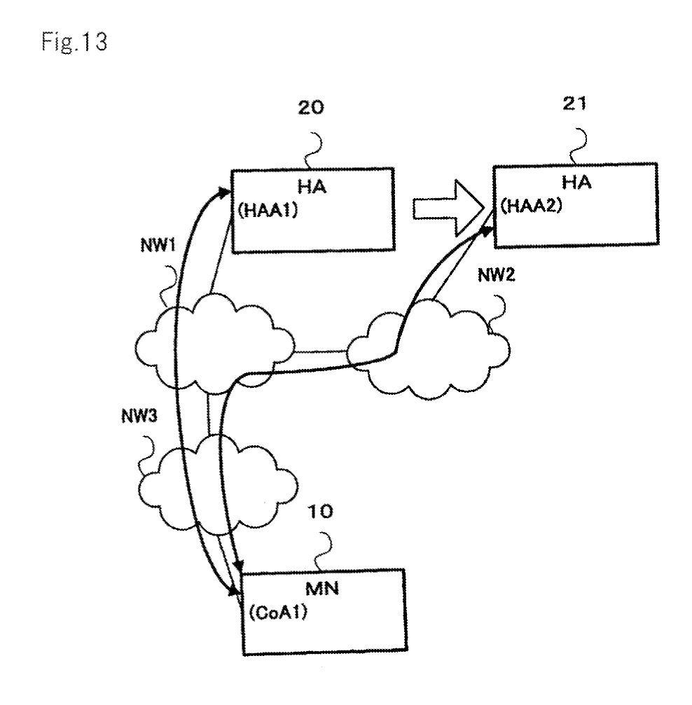

FIG. 13 is a schematic diagram illustrating a flow of data in the case in which after the home agent that registers the location of MN10 has been switched from HA 20 to HA 21, MN10 has turned on the Multi HA Address Opt flag and transmitted the registration request and then HA 21 to which the home agent had been switched has registered a combination of CoA1 and HAA1 and a combination of CoA1 and HAA2. Referring to the drawing, since IP tunnels corresponding to a plurality of HAAs have been registered, after the home agent has been switched, MN10 can transmit data through the plurality of IP tunnels.

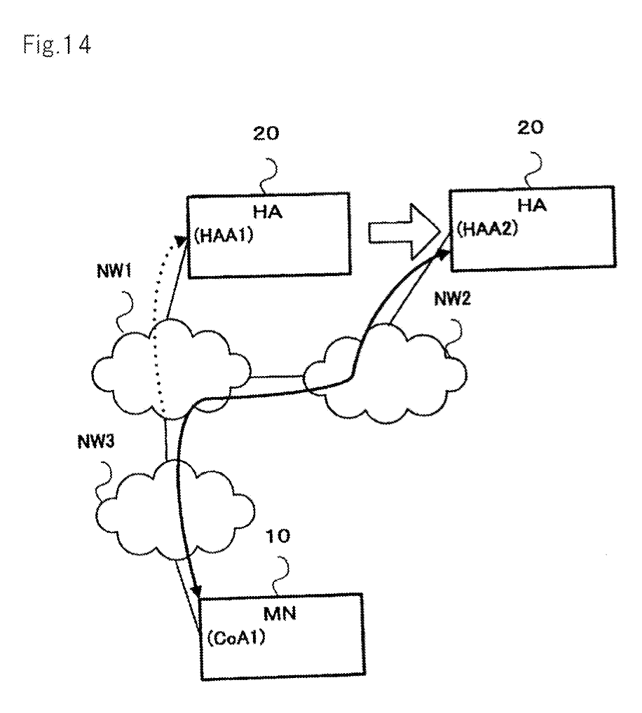

In contrast, as shown in FIG. 14, when the Multi HA Address Opt flag is turned off or when an ordinary registration packet that does not contain the Multi HA Address Opt flag is transmitted after the home agent is switched, CoA1 is just correlated with HAA2 and registered. Thus, MN10 cannot transmit data through an IP tunnel corresponding to CoA1 and HAA1 that have not been registered.

In this embodiment, although HA 20 refers to the Multi HA Address Opt flag and simultaneously registers a plurality of HAAs based on the flag, if all mobile nodes whose locations HA 20 registers are terminals that correspond to multiple simultaneous registration of HAAs, even if the Multi HA Address Opt flag is not contained in the packet, HA 20 can simultaneously register a plurality of HAAs.

In this embodiment, although communication system 1 uses the Mobile IP as a communication protocol, it can use another communication protocol such as proxy mobile IP as long as the protocol can use tunnels.

In this embodiment, although MN10 is a mobile node, it may be a communication device that obtains a tunnel address and requests the communication party (HA 20) to register the obtained tunnel address, for example, a communication device that operates as an MAG (Mobile Access Gateway).

In this embodiment, HA 20 may be a communication device that manages CoA and HAA used for an IP tunnel and register them to itself, for example, a communication device that operates as an LMA (Local Mobility Anchor).

In this embodiment, although HA 20 registers a care-of address and a home agent address, it may register other information as long as it is tunneling information (tunnel addresses) that each node (MN10, HA 20) sets up for tunnel interfaces. For example, when an IP-VPN (Virtual Private Network) is used, HA 20 can register a label allocated to each communication interface as a tunnel address.

In this embodiment, although the node (second communication device) of the communication party of MN10 (first communication party) is HA 20 (tunnel management server) itself, the tunnel management server can set up an IP tunnel for a node other than HA 20 as the communication party of MN10.

As described above, according to this embodiment, when HA 20 (tunnel management server) receives a registration packet (setup request) that causes CoA (first tunnel address) and HAA (second tunnel address) to be registered, if there is a plurality of second tunnel addresses, since HA 20 combines the first tunnel address and the plurality of second tunnel addresses and sets up a plurality of tunnels, whenever MN10 (first communication device) changes a communication path, the tunnel management server does not need to set up a tunnel, nor does it need to notify MN10 of the change and thereby the communication efficiency between the communication devices improves.

In addition, when HA 20 receives a registration packet with the Multi HA Address Opt flag turned on (multiple setup request), since HA 20 simultaneously registers IP tunnels corresponding to the plurality of HAAs, communication system 1 allows the mobile node (MN10) according to the present invention and ordinary mobile nodes that do not correspond to the multiple setup registration of HAAs to coexist in a registered location area.

When the communication speed at which MN10 communicates becomes equal to or lower than a predetermined value, since it turns on the Multi HA Address Opt flag, it can prevent communication quality from deteriorating.

Since communication system 1 uses the Mobile IP or proxy Mobile IP as a communication protocol, the present invention can be applied to mobile nodes.

### Second Embodiment

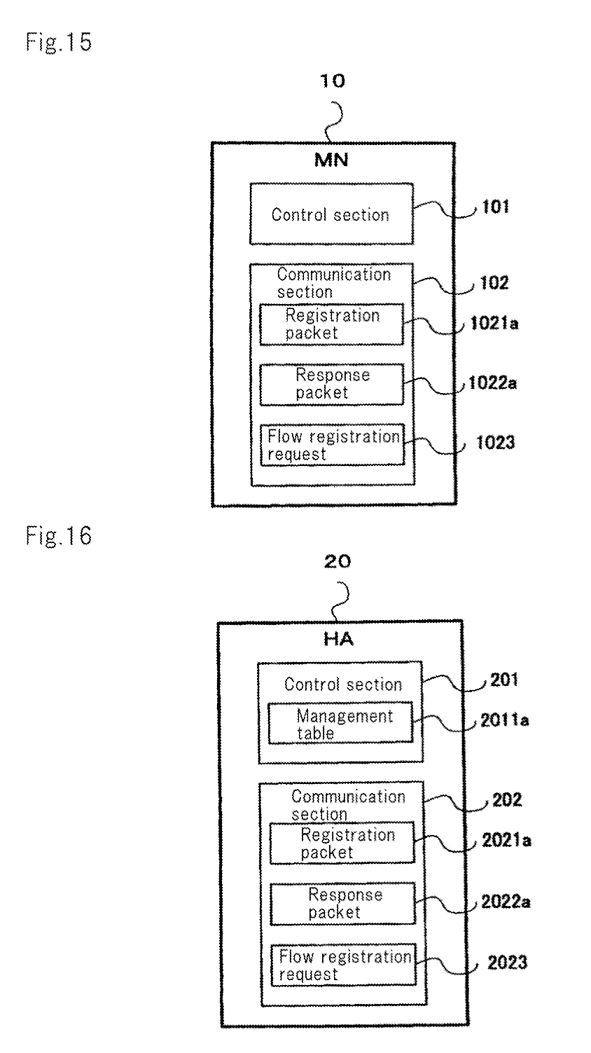

A second embodiment of the present invention will be described. FIG. 15 is an overall view illustrating a structure of MN10 according to this embodiment. Referring to the drawing, the structure of MN10 according to this embodiment is similar to that of MN10 according to the first embodiment except that MN10 according to the second embodiment also transmits flow registration request 1023 and also transmits and receives registration packet 1021a and response packet 1022a instead of registration packet 1021 and response packet 1022.

When communication section 102 transmits packets through a plurality of flows, communication section 102 turns on the Multi HA Address Opt flag and transmits registration packet 1021a that contains CoA identifier that identifies CoA. As a CoA identifier, for example, an 8-bit value is allocated.

In addition, communication section 102 transmits flow registration request 1023 that specifies an IP tunnel to be used for each flow. In this example, a flow is specified by the address and port number of MN10 and the address and port number of the transmission destination. On the other hand, an IP tunnel is specified by a combination of CoA identifier and HAA identifier.

Communication section 102 receives response packet 1022a that contains HAA identifier that identifies the address of each registered HAA.

FIG. 16 is an overall view illustrating a structure of HA 20 according to this embodiment. Referring to the drawing, the structure of HA 20 according to this embodiment is similar to that of mobile node 10 according to the first embodiment except that HA 20 according to the second embodiment also receives flow registration request 2023 and transmits and receives registration packet 2021a and response packet 2022a instead of registration packet 2021 and response packet 2022 and stores management table 2011a instead of management table 2011.

HA 20 correlates individually setup IP tunnels with flow information that flow registration request 2012 represents and stores the correlated IP tunnels and flow information in management table 2011a.

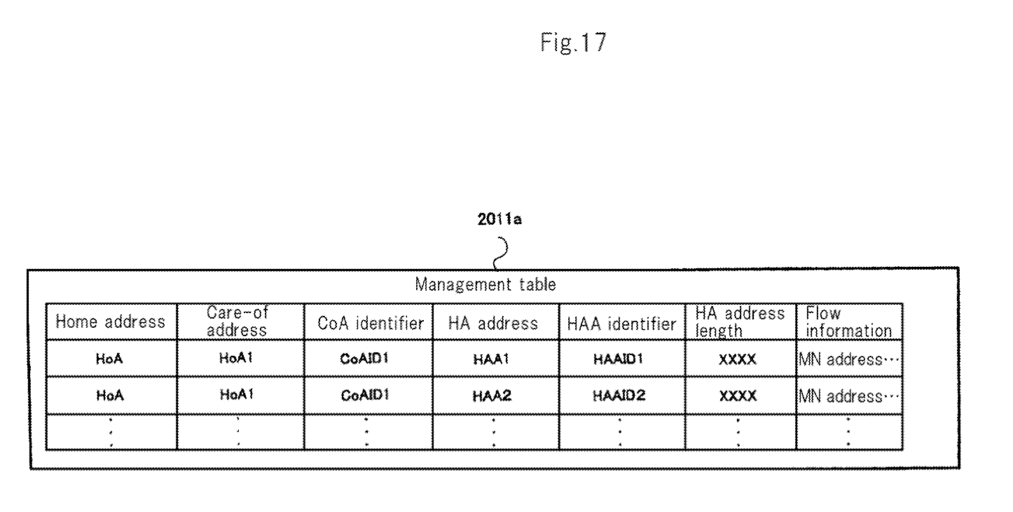

FIG. 17 is a table listing contents stored in management table 2011a according to this embodiment. Referring to the drawing, management table 2011a is similar to management table 2011 according to the first embodiment except that management table 2011a also stores “CoA identifier,” “HAA identifier,” and “flow information.”

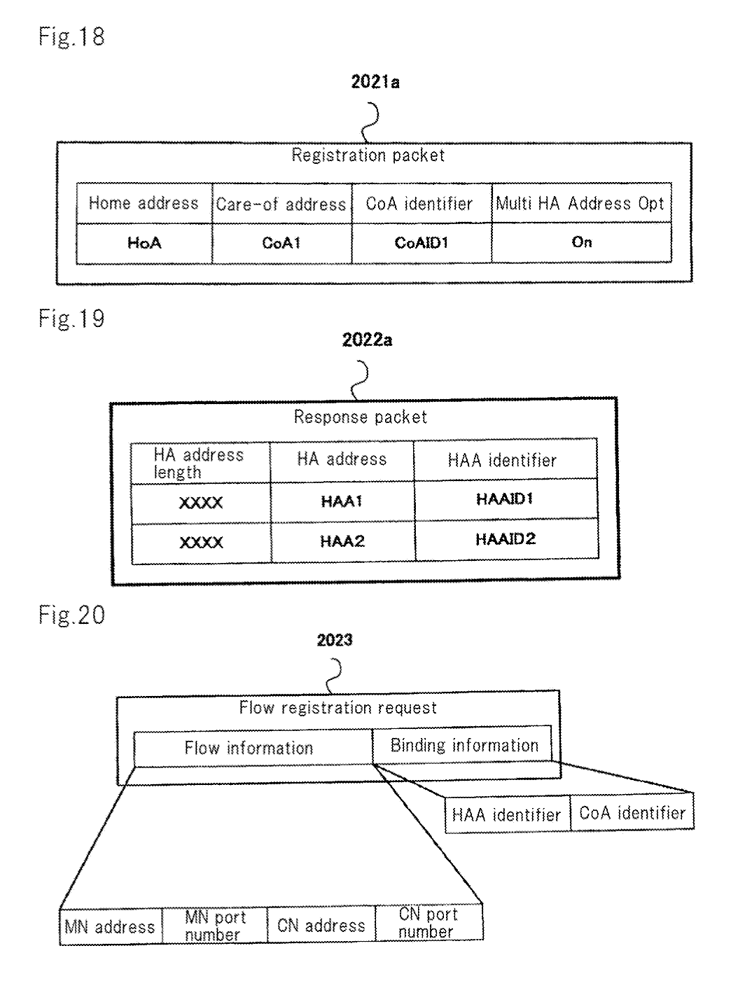

FIG. 18 is a diagram illustrating information contained in registration packet 2021a according to this embodiment. Referring to the drawing, registration packet 2021a is different from registration packet 2021 according to the first embodiment in that registration packet 2021a also contains information that represents “CoA identifier” that identifies CoA.

FIG. 19 is a diagram illustrating information contained in response packet 2022a according to this embodiment. Referring to the drawing, response packet 2022a is similar to response packet 2022 according to the first embodiment except that response packet 2022a also contains “HAA identifier.”

FIG. 20 is a diagram illustrating information contained in flow registration request 2023. Referring to the drawing, flow registration request 2023 contains flow information and binding information. The flow information is information that identifies a flow and contains information that represents “MN address,” “MN port number,” “CN address,” and “CN port number.”

“MN address” and “MN port number” are the IP address and the port number of MN10. “CN address” and “CN port number” are the IP address and the port number of the communication party.

The binding information contains “CoA identifier” and “HAA identifier” that identify CoA and HAA, respectively. As these identifiers, for example 8-bit values are allocated.

Flow registration request 2023 correlates combinations of “CoA identifier” and “HAA identifier” with each flow identified by “MN address,” “MN port number,” “CN address,” and “CN port number.” MN10 may correlate one flow with a plurality of combinations (IP tunnels) or one combination with a plurality of flows.

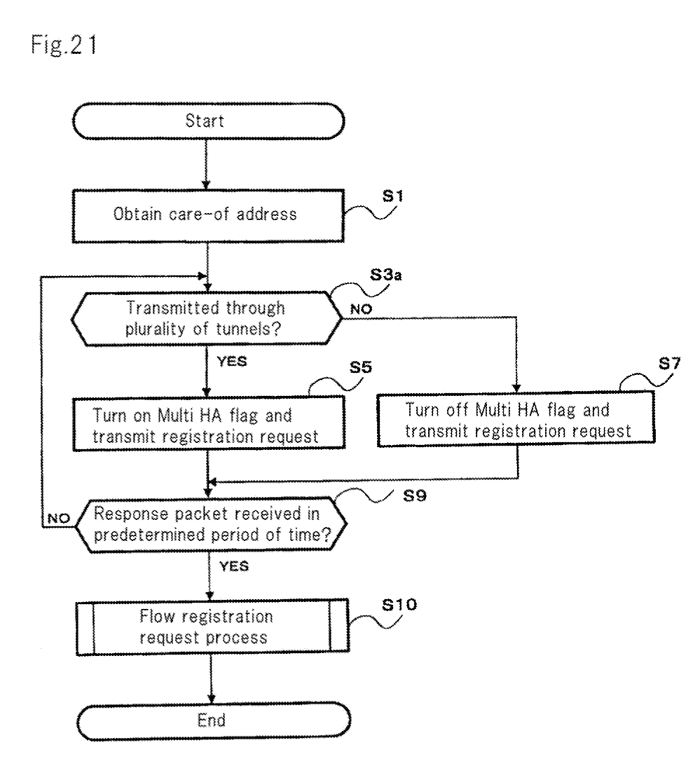

FIG. 21 is a flow chart illustrating an operation of MN10 according to this embodiment. Referring to the drawing, the operation of MN10 is similar to that of MN10 according to the first embodiment except that MN10 according to the second embodiment executes step S3a instead of step S3; and a flow registration request process (at step S10) instead of steps S9, S11.

After obtaining a care-of address (at step S1), MN10 determines whether or not it needs to transmit packets through a plurality of IP tunnels for any flow (at step S3a). For example, when MN10 is connected to a content delivery network and delivers a video steam having a high real time property, a plurality of tunnels are set up for this flow that delivers the stream so as to maintain the communication quality of the stream.

When packets need to be transmitted through a plurality of IP tunnels (at step S3a: YES), MN10 turns on the Multi HA Address Opt flag (at step S5). When packets do not need to be transmitted through the plurality of IP tunnels (at step S3a NO), MN10 turns off the Multi HA Address Opt flag (at step S7).

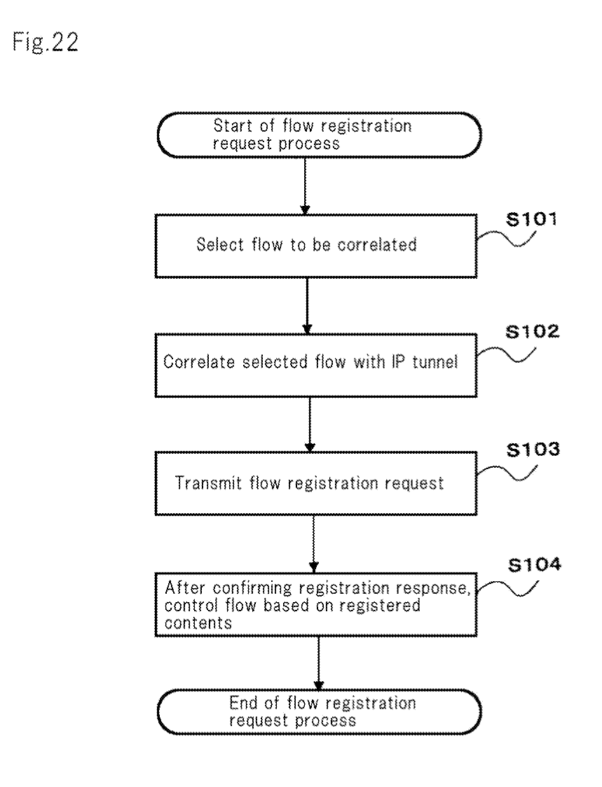

FIG. 22 is a flow chart illustrating a flow registration request process. Referring to the drawing, MN10 selects a flow that transmits data through an IP tunnel from those that deliver data that MN10 itself transmits and receives (at step S101).

MN10 correlates the selected flow with an IP tunnel (at step S102). MN10 transmits flow registration request 1023 that represents the correlated flow and IP tunnel to HA 20 (at step S103). After confirming a registration response from HA 20, MN10 controls the flow through the correlated IP tunnel (at step S104). After step S104, MN10 completes the flow registration request process.

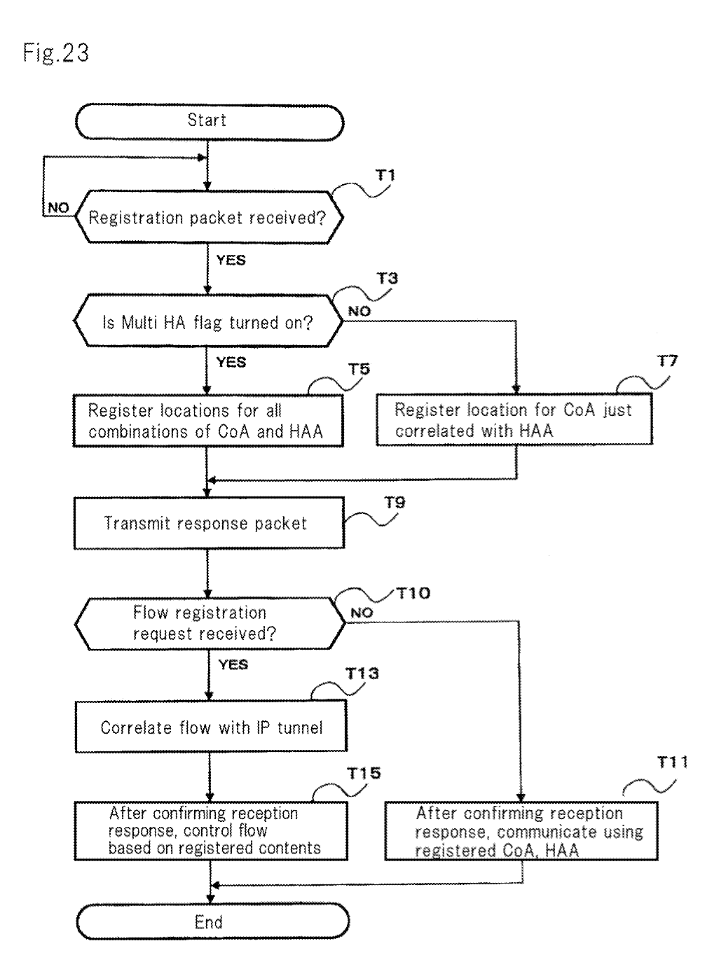

FIG. 23 is a flow chart illustrating an operation of HA 20 according to this embodiment. Referring to the drawing, the operation of HA 20 according to this embodiment is similar to that of HA 20 according to the first embodiment except that HA 20 according to the second embodiment also executes steps T10, T13, and T15.

After transmitting a response packet (at step T9), HA 20 determines whether or not it has received flow registration request 2023 (1023) in a predetermined period of time (at step T10). When HA 20 has received flow registration request 2023 (at step T10: YES), HA 20 correlates the flow that flow registration request 2023 requires with an IP tunnel and registers the correlated flow and IP tunnel in management table 2011a (at step S13). Then, HA 20 communicates using the correlated flow through the correlated IP tunnel (at step T15).

When HA 20 has not received flow registration request 2023 (at step T10: NO), HA 20 executes step T11. After step T11 or T15, HA 20 completes the operation.

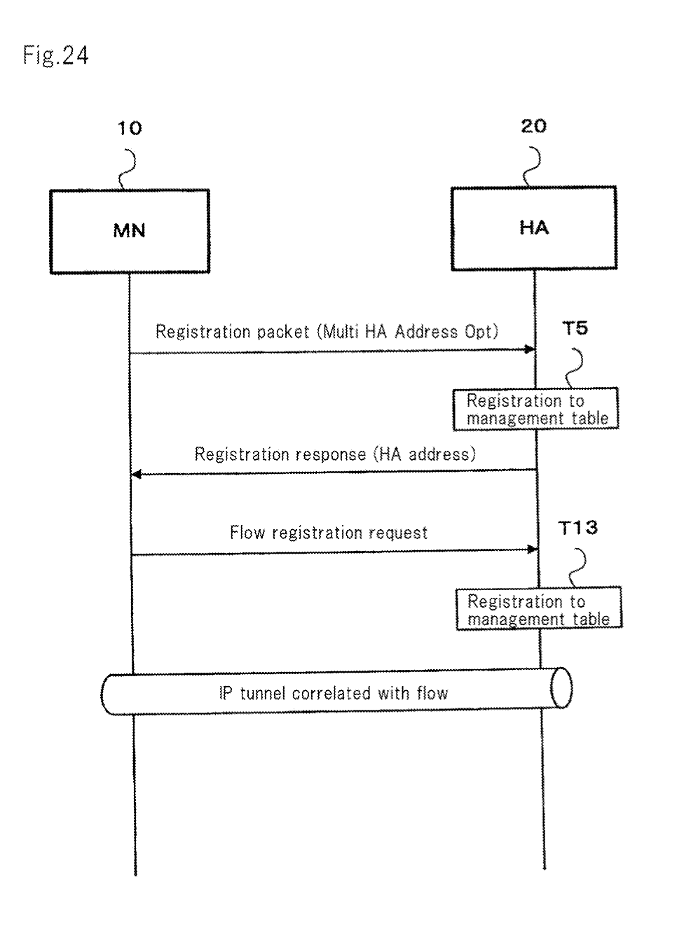

FIG. 24 is a sequence chart illustrating an operation of communication system 1a according to this embodiment. Referring to the drawing, when MN10 turns on the Multi HA Address Opt flag and transmits a registration request with this flag (at step S5), HA 20 registers a plurality of HAAs in management table 2011a (at step S5). Then, HA 20 transmits response packet 2022a containing the registered HAAs to MN10 (at step TT9).

MN10 transmits flow registration request 1023 that causes a flow to be correlated with an IP tunnel and registered (at step S103) and then HA 20 correlates the flow with the IP tunnel (CoA, HAA) and registers the correlated flow and IP tunnel in management table 2011a (at step T13).

After the registration, MN10, HA 20 initiate communication using the registered flow through the correlated IP tunnel (at steps S104, T15).

In this embodiment, although MN10 identifies a flow by an IP address and a port number, MN10 may specify a mask corresponding to a network address to identify a flow as an address block.

As described above, according to this embodiment, since MN10 (first communication device) selects any one of the combinations of registered CoA(s) and HAA(s) and also transmits flow registration request 2023 (1023) that causes the flow to be correlated with the selected combination and to be registered in HA 20 (tunnel management server), then the tunnel management server correlates the flow with the combination and registers the correlated flow and combination, communication system 1 can improve communication quality corresponding to the flow and thereby further improve the communication efficiency.

### Third Embodiment

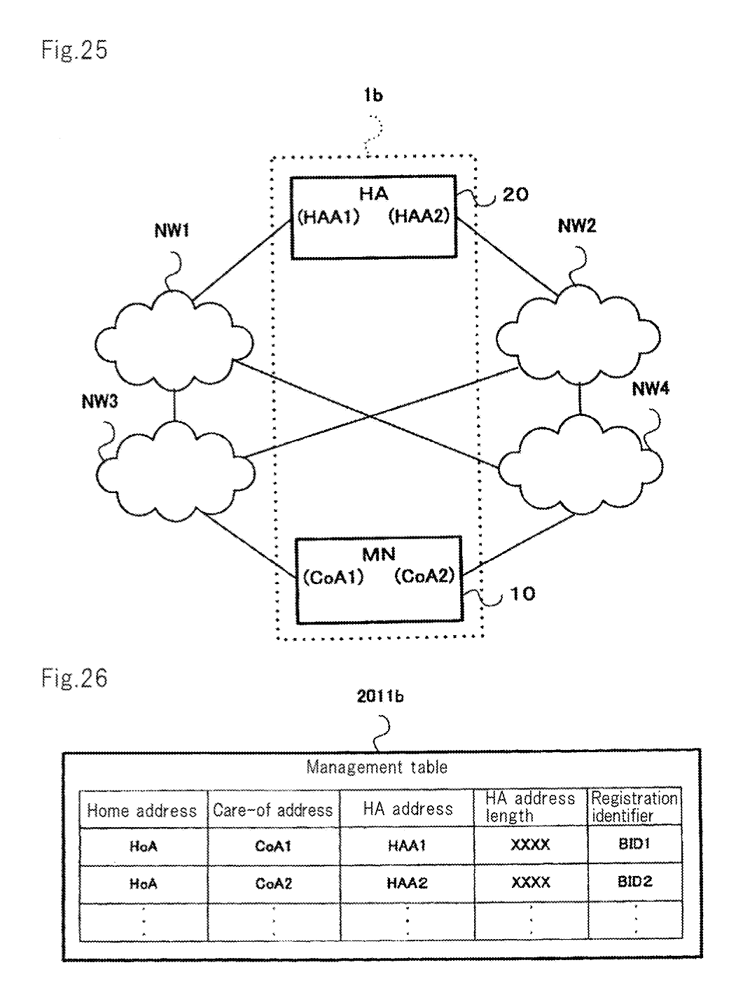

A third embodiment of the present invention will be described. FIG. 25 is an overall view illustrating a structure of communication system 1b according to this embodiment.

Communication system 1b according to this embodiment is different from communication system 1a according to the second embodiment in that communication system 1b according to the third embodiment uses the MCoA (Multi Care-of Address) format in which HA 20 can register a plurality of CoAs for one MN. MN10 is connected to a plurality of networks such as NW3, NW4 and obtains CoAs corresponding to the networks.

MN10 can request HA 20 to register a plurality of CoAs. When the Multi HA Address Opt flag is turned on, HA 20 registers all combinations of HAAs and CoAs. HA 20 transmits response packet 2022b that contains a registration identifier that identifies combinations of HAAs and CoAs to MN10.

MN10 transmits a flow registration request that represents a flow and an IP tunnel (registration identifier) to HA 20 and then it accordingly correlates the flow with the IP tunnel and registers the correlated flow and IP tunnel.

FIG. 26 is a table listing contents stored in management table 2011b according to this embodiment. Referring to the drawing, management table 2011b is different from management table 2011a according to the second embodiment in that management table 2011b stores “registration identifier” instead of CoA identifier and HAA identifier.

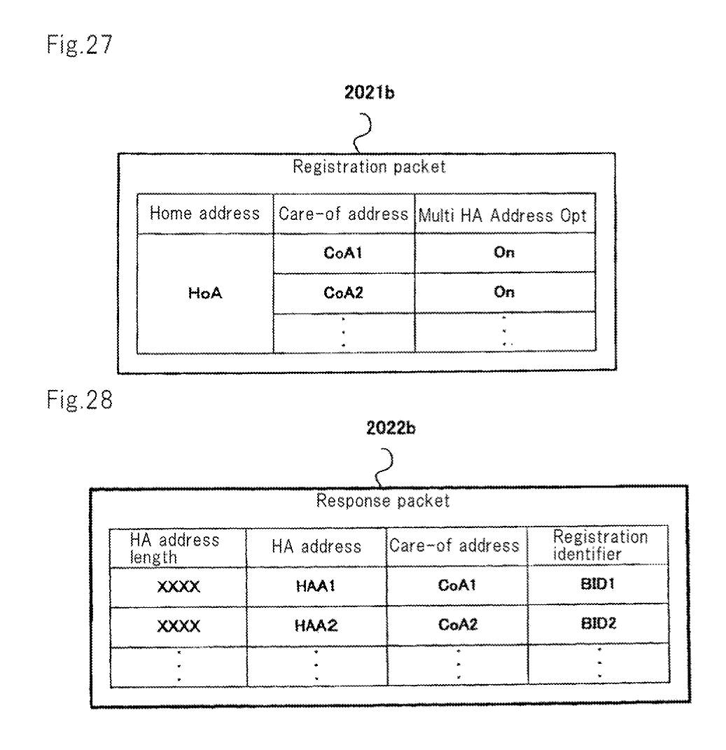

FIG. 27 is a diagram illustrating information contained in registration packet 2021b according to this embodiment. Referring to the drawing, registration packet 2021b is different from registration packet 2021a according to the second embodiment in that registration packet 2021b contains a plurality of CoAs, not CoA identifier. This is because in this embodiment, MN10 specifies an IP tunnel with a registration identifier instead of a combination of CoA identifier and HAA identifier.

FIG. 28 is a diagram illustrating information contained in response packet 2022b according to this embodiment. Referring to the drawing, response packet 2022b is different from response packet 2022a in that response packet 2022b contains a “registration identifier” instead of an HAA identifier and also contains registered “care-of address.”

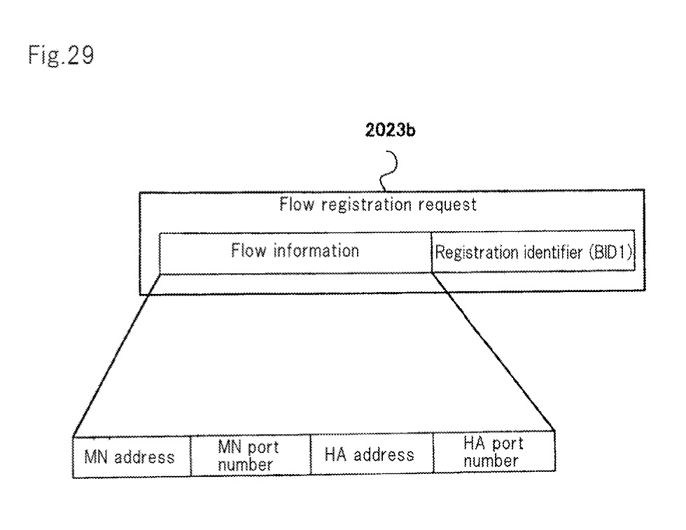

FIG. 29 is a diagram illustrating information contained in flow registration request 2023b according to this embodiment. Referring to the drawing, flow registration request 2023b is different from flow registration request 2023 according to the second embodiment in that flow registration request 2023b contains information that represents a “registration identifier” instead of a CoA identifier and HAA identifier. A “Registration identifier” is an identifier that identifies a combination of CoA and HAA has have been registered.

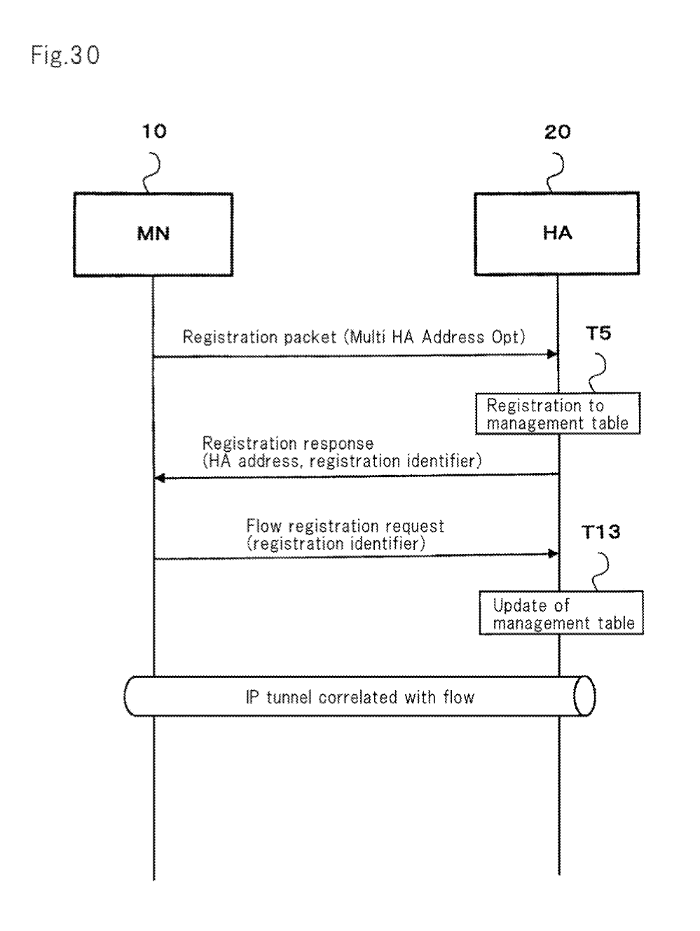

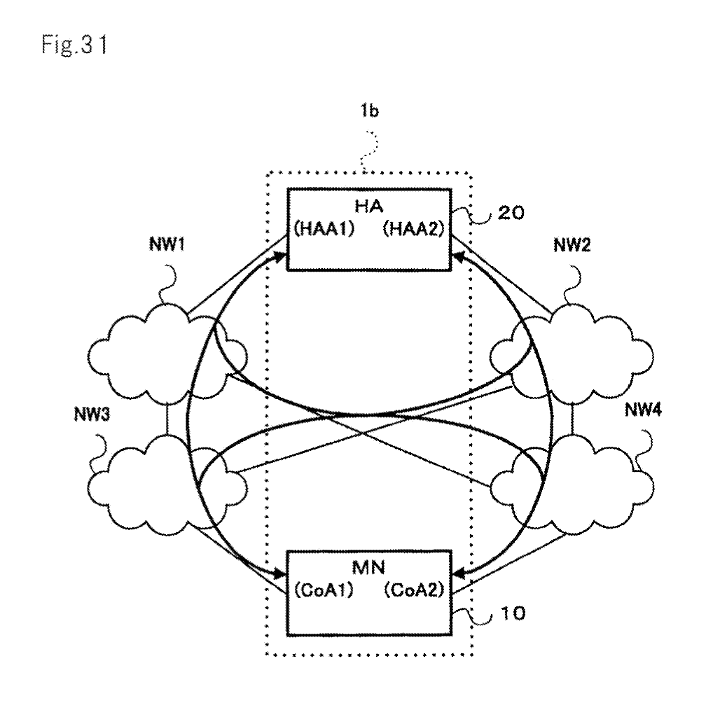

FIG. 30 is a sequence chart illustrating an operation of communication system 1b according to this embodiment. Referring to the drawing, when MN10 turns on the Multi HA Address Opt flag and transmits a multiple CoA registration request (at step S5), HA 20 registers all combinations of a plurality of HAAs and CoAs in Management table 2011b (at step T5). Then, HA 20 transmits response packet 2031b that contains a “registration identifier” that represents the registered combinations to MN10 (at step TT9).

MN10 transmits flow registration request 2012b that causes a flow to be correlated with an IP tunnel (registration identifier) and to be registered (set up) (at step S103) and then HA 20 correlates the flow with IP tunnel (CoA, HAA) and registers the correlated flow and IP tunnel in management table 2011b (at step T13).

After the registration, MN10, HA 20 initiate communication using the registered flow through the correlated IP tunnel (at steps S104, T15).

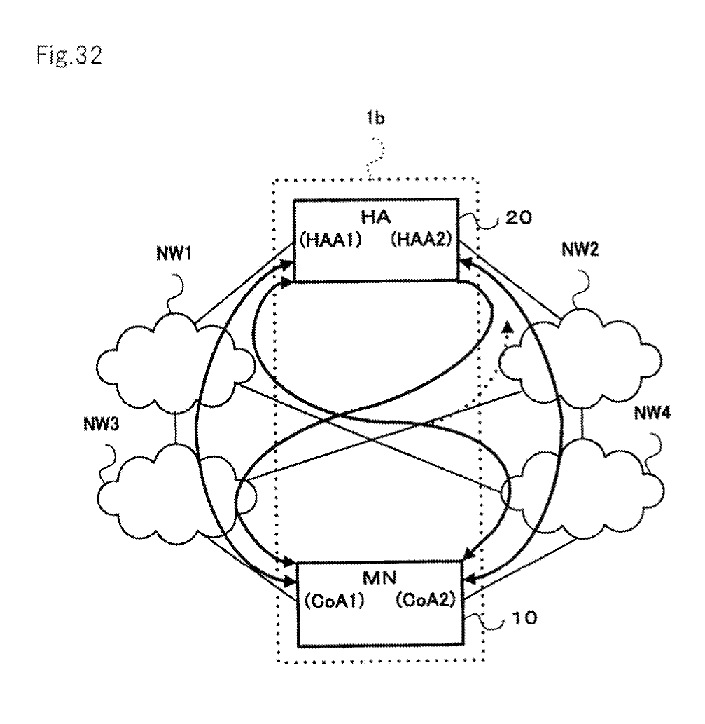

FIG. 31 is a schematic diagram illustrating a flow of data in the case in which MN10 has turned on the Multi HA Address Opt flag and transmitted the corresponding registration request and then HA 20 has registered all combinations of CoA1 and CoA2 as one side tunnel interfaces and HAA1 and HAA2 as the other side tunnel interfaces. As shown in the drawing, since MN10 (first communication device) has caused a plurality of HAAs to be registered, MN10 can transmit data through a plurality of networks (NW1, NW2) on the side of HA 20 (second communication device). Thus, MN10, HA 20 can efficiently communicate with each other.

In contrast, as shown in FIG. 32, when the Multi HA Address Opt flag is turned off or when an ordinary registration packet that does not contain the Multi HA Address Opt flag is transmitted, one HAA (HAA1 or the like) is registered corresponding to CoA1 or CoA2. Thus, MN10 cannot transmit data through a network (NW2) corresponding to HAA2 that has not been registered. As a result, communication between MN10, HA 20 becomes inefficient.

As described above, according to this embodiment, since communication system 1b can register a plurality of CoAs, it can set up as many IP tunnels as are the number of combinations of CoAs and HAAs, thus communication system 1b can further improve the communication efficiency.

All or a part of the flow charts shown in FIGS. 7, 8, and 21 to 23 can be accomplished by executing a computer program.

The present application claims a priority based on Japanese Patent Application JP 2009-009851 filed on Jan. 20, 2009, the entire contents of which are incorporated herein by reference in its entirety.

1. A communication system, comprising:
a first communication device that transmits a setup request that causes a tunnel to be set up such that a first tunnel address of said first communication device and a second tunnel address of a second communication device are tunnel interfaces; and
a tunnel management server that receives said setup request from said first communication device and that, when said second communication device has a plurality of said second tunnel addresses, combines said plurality of second tunnel addresses and said first tunnel address and sets up a plurality of tunnels.

2. The communication system according to claim 1,
wherein said first communication device also transmits a multiple setup request that causes tunnels to be set up such that said plurality of second tunnel addresses will become said tunnel interfaces, and
wherein said tunnel management server receives said multiple setup request and that, when said second communication device has said plurality of second tunnel addresses, sets up said plurality of tunnels.

3. The communication system according to claim 2,
wherein when a communication speed of said first communication device is equal to or lower than a predetermined value, said first communication device transmits said multiple setup request.

4. The communication system according to claim 1,
wherein said first communication device selects any one of said plurality of tunnels that have been set up by said tunnel management server and also transmits a flow registration request information that causes a flow that delivers data that said first communication device transmits and receives to be correlated with the selected tunnel and registered;
wherein said tunnel management server correlates said flow represented by said flow registration request with said tunnel and registers the correlated flow and tunnel, and
wherein said first communication device transmits and receives data of said flow registered by said tunnel management server through said tunnel correlated with the flow.

5. The communication system according to claim 1,
wherein said first communication device has a plurality of said first tunnel addresses, and
wherein said tunnel management server combines each of said plurality of first tunnel addresses and said plurality of second tunnel addresses so as to set up said plurality of tunnels.

6. The communication system according to claim 1,
wherein said communication system uses Mobile IP as a communication protocol,
wherein said first communication device is a mobile communication device, and
wherein said tunnel management server is a home agent.

7. The communication system according to claim 6,
wherein said Mobile IP is proxy Mobile IP,
wherein said mobile communication device is a mobile access gateway, and
wherein said home agent is a local mobility anchor.

8. The communication system according to claim 6,
wherein said first tunnel address is a care-of address, and
wherein said second tunnel address is a home agent address.

9. A tunnel management server, comprising:
reception section that receives a setup request that causes a tunnel to be set up such that a first tunnel address of a first communication device and a second tunnel address of a second communication device are tunnel interfaces; and
setup section that receives said setup request from said reception section and that, when said second communication device has a plurality of said second tunnel addresses, combines said plurality of second tunnel addresses and said first tunnel address and sets up a plurality of tunnels.

10. A communication device that transmits a multiple setup request that causes a plurality of tunnels to be set up such that a first tunnel address of a first communication device and a second tunnel address of a second communication device are tunnel interfaces.

11. A tunnel setup method, comprising:
transmitting a setup request that causes a tunnel to be set up such that a first tunnel address of said first communication device and a second tunnel address of a second communication device are tunnel interfaces; and
receiving said setup request from said first communication device and that, when said second communication device has a plurality of said second tunnel addresses, combining said plurality of second tunnel addresses and said first tunnel address and setting up a plurality of tunnels.

12. A computer readable medium comprising instructions for causing a computer to perform a tunnel setup method, the method comprising:
receiving a setup request that causes a tunnel to be set up such that a first tunnel address of a first communication device and a second tunnel address of a second communication device are tunnel interfaces; and
receiving said setup request from said reception step and that, when said second communication device has a plurality of said second tunnel addresses, combining said plurality of second tunnel addresses and said first tunnel address and setting up a plurality of tunnels.
